(19) United States
(12) Patent Application Publication
(10) Pub. No.: US 2017/0084106 A1
(43) Pub. Date: Mar. 23, 2017

(54) GAMING DEVICES HAVING INTERFACES FOR DETECTING MULTIPLE USERS

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/268,595

(22) Filed: Sep. 18, 2016

Related U.S. Application Data
(60) Provisional application No. 62/222,416, filed on Sep. 23, 2015.

(51) Int. Cl. G07F 17/32

(52) U.S. Cl. CPC G07F 17/3206; G07F 17/322; G07F 17/3237

(57) ABSTRACT

A gaming device that is configured to recognize simultaneous input from multiple players. The gaming device includes at least three wireless signal detectors. The wireless signal detectors are configured to measure a wireless signal strength received from a wireless device uniquely associated with a player. The gaming device includes a controller that triangulates the wireless signal strength measured by the wireless signal detectors to estimate a position of the wireless device. Based on the position of the wireless device, inputs to the gaming device may be attributable to the player associated with the wireless device. Because of this, multiple inputs from multiple players may be received simultaneously by the gaming device without separately assigned inputs for each player.

### RELATED APPLICATION DATA

This application is a non-provisional of and claims priority to U.S. Provisional Application Ser. No. 62/222,416, filed Sep. 23, 2015.

### FIELD OF THE INVENTION

The disclosed embodiments relate to a gaming device, a gaming system, and a gaming method. More specifically, the disclosed embodiments relate to gaming devices have multiple user detectable interfaces without the need for user specific inputs.

### BACKGROUND

Gaming, including wagering games, is a popular pastime for many individuals. People enjoy casual gaming via home consoles and computers as well as destination wagering gaming at resorts or casinos at popular locations. Game operators thus continually look for ways to make gaming more convenient and exciting for players to attract players to their properties or to play their games.

Accordingly, casino gaming machines and automated or semi-automated gaming tables have been developed to facilitate gaming. Such gaming devices provide a faster pace of game play, as well as automated game scoring and accounting. Other features such as loyalty programs, progressive jackpots or lotteries, side wagers, promotions, and other features have been incorporated into such gaming devices.

One drawback of such automation is the ability to simply and efficiently conduct multi-player games. For example, gaming machines are generally configured for a single player. Where a gaming machine hosts a multi-player game, the gaming machine generally provides for two or more sets of inputs (one for each player), or each player must participate at a separate gaming machine. At a gaming table, different player stations may be provided with separate inputs (one for each player) in order to track which player takes which action at the gaming table. Where a gaming machine or gaming table has only a single input or area, the game must be controlled so that each player only provides an input during his or her turn, such that the input is attributable to the correct player.

While these approaches to multi-player games have implemented, none of these approaches allows a configuration where a truly natural and intimate multi player experience can be achieved. Accordingly, there is a need for a better interface for a multi-player gaming device without requiring successive player turns or separate player inputs.

### SUMMARY

Accordingly, a gaming device, a gaming system, and method of providing inputs from multiple players simultaneously without the need for player-specific inputs on the device is provided. For example, a gaming device is configured to recognize simultaneous input from multiple players. The gaming device includes at least three wireless signal detectors. The wireless signal detectors are configured to measure a wireless signal strength received from a wireless device uniquely associated with a player.

The gaming device includes a controller that triangulates the wireless signal strength measured by the wireless signal detectors to estimate a position of the wireless device. Based on the position of the wireless device, inputs to the gaming device may be attributable to the player associated with the wireless device. Because of this, multiple inputs from multiple players may be received simultaneously by the gaming device without separately assigned inputs for each player.

Further objects, features, and advantages of the present invention over the prior art will become apparent from the detailed description of the drawings which follows, when considered with the attached figures.

### BRIEF DESCRIPTION OF THE DRAWINGS

FIG. 1 illustrates a gaming table with a multiple user interface, according to one exemplary embodiment.

FIG. 2 illustrates a gaming table with two or more players providing input simultaneously.

FIG. 3 illustrates a casino gaming machine with a multiple user interface, according to one exemplary embodiment.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing games or interacting with gaming devices. In various embodiments, the methods and control of game play are implemented via a gaming table, a casino gaming machine, or other gaming device.

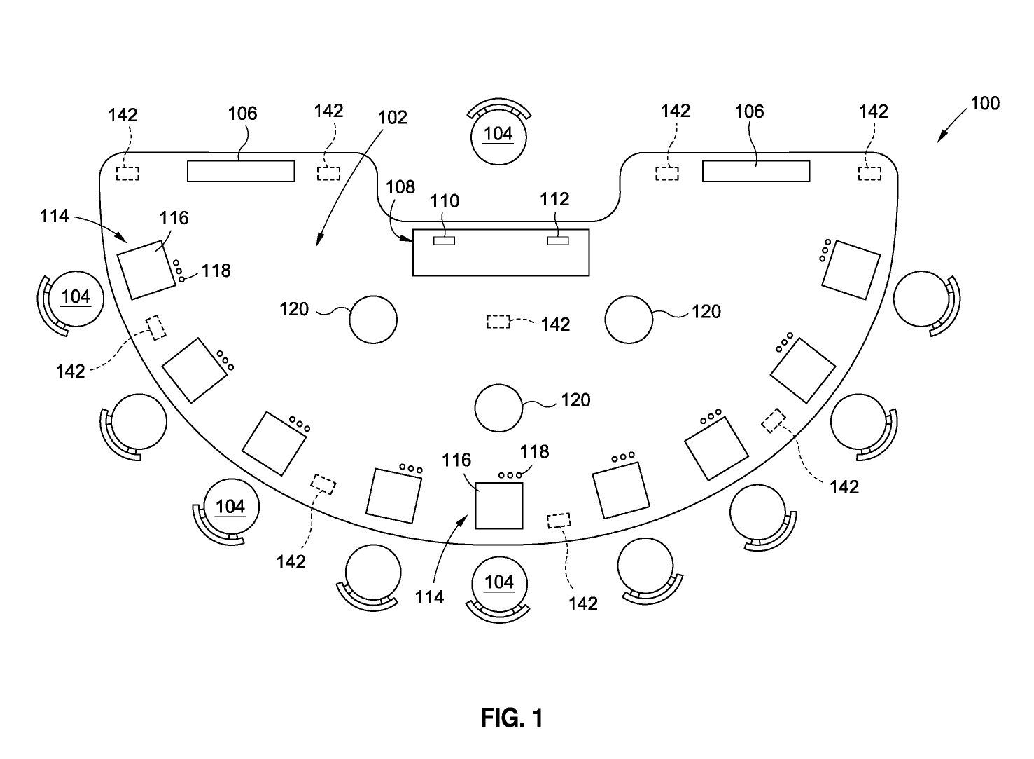

In one embodiment, a gaming table 100 is provided, as shown in FIG. 1. The gaming table 100 includes a playing surface 102. The playing surface 102 may be any suitable playing surface, such as a hard gaming surface with a felt overlay. Information may be printed on or displayed by the playing surface such as logos, the name of the game being played, one or more pay tables, and the like.

The gaming table 100 may further include a number of chairs or stools 104 that surround the table 100. The chairs or stools 104 may correspond to a dealer station 108 and a plurality of player stations 114. In other embodiments, the gaming table 100 may be configured at a height where players, or the majority of the players, play while standing. The gaming table 100 may have various shapes and sizes, such as depending upon the number of player stations. In the example which is illustrated, the gaming table 100 is generally semi-circular or U-shaped, whereby the dealer is located at one side of the table opposing the player(s).

In some embodiments, the gaming table 100 may comprise one or more displays 106. Preferably, the displays are electronic video displays, such as CRT, LCD, LED, OLED or other types of electronic display devices now known or later developed. The displays 106 may present information concerning the game such as a pay table, rules, a progressive jackpot, or a current status of the game. The gaming table 100 may have various associated game data capture or collection devices (not shown) such as card readers, chip readers, overhead cameras or the like. For example, an overhead camera might capture game play at the gaming table 100, which video is displayed on the displays 106 or external displays or other devices. Players and/or other onlookers may observe the play at the gaming table 100 via the displays.

As mentioned above, the gaming table 100 comprises a dealer station 108 and a plurality of player stations 114. The dealer station 108 may comprise a number of devices or features that the dealer may utilize to control, monitor and/or present a game at the table 100. For example, the dealer station may include input devices 110 such as buttons, a keyboard, or the like. The dealer station may also include a random card shuffler 112. Other tools may also be incorporated such as a dealer display and/or touch screen, or other devices now known or later developed.

The player stations 114 each include a number of devices or features to facilitate the game play for each player. For example, the player stations 114 may comprise a play area 116 for player cards or other playing pieces used in the play of the game. A number of other input devices 118, such as wager input detectors or buttons, may also be included. For example, a player may place one or more chips encoded with an RF tag onto a wager input detector 118 which detects the player's wager and the amount of the wager and communicates that information to the dealer station 108. Any other number of player station devices may be incorporated.

In some embodiments, community game playing areas 120 may be incorporated onto or be provided at the gaming table 100. In the community player areas 120, wagers may be placed or cards may be played according to game rules. For example, bonus wagers for a progressive jackpot or other prize may be placed in the community player areas 120, or community cards or other game pieces as part of a game may be played in the areas 120.

The gaming table 100 may be configured to track or monitor the game play at the table. For example, card shuffling device 112, the overhead camera, or RF detectors may detect cards or gaming pieces that are distributed and played by the players, wagers made by the players, and may track game outcomes including the winnings and losses of the players. The tracked play of each player on the gaming table 100 may also be linked with a player's loyalty account, a monetary account, a back-end accounting system or other accounts or systems. For example, the table may have a game controller that is communicatively connected with a game server and loyalty account server. The play of the player, including credits wagered, won, and lost may be tracked via the game server and the loyalty account server.

In one exemplary embodiment, the gaming table 100 includes a plurality of WiFi readers or detectors 142 (although referred to as WiFi readers herein, the devices might operate using conventional WiFi technology, including on the 2.4 GHz and 5 GHz bands, but might also comprise other wireless readers or detectors, including those using other protocols or bands, such as Bluetooth, NFC or the like). The WiFi readers 142 are configured to detect a position of a device relative to the playing surface 102 of the gaming table 100, as described in more detail below.

The WiFi readers 142 are disposed embedded throughout the playing surface 102 of the gaming table 100. As shown in FIG. 1, there are nine WiFi readers 142 on the playing surface 102. Of these, eight WiFi readers 142 are disposed around a perimeter of the gaming table 100, and one WiFi reader 142 is disposed in the middle of the gaming table 100. However, any number or arrangement of WiFi readers may be incorporated and their location may vary (including by being located in other structures adjacent to the table, such as a table rail or the like).

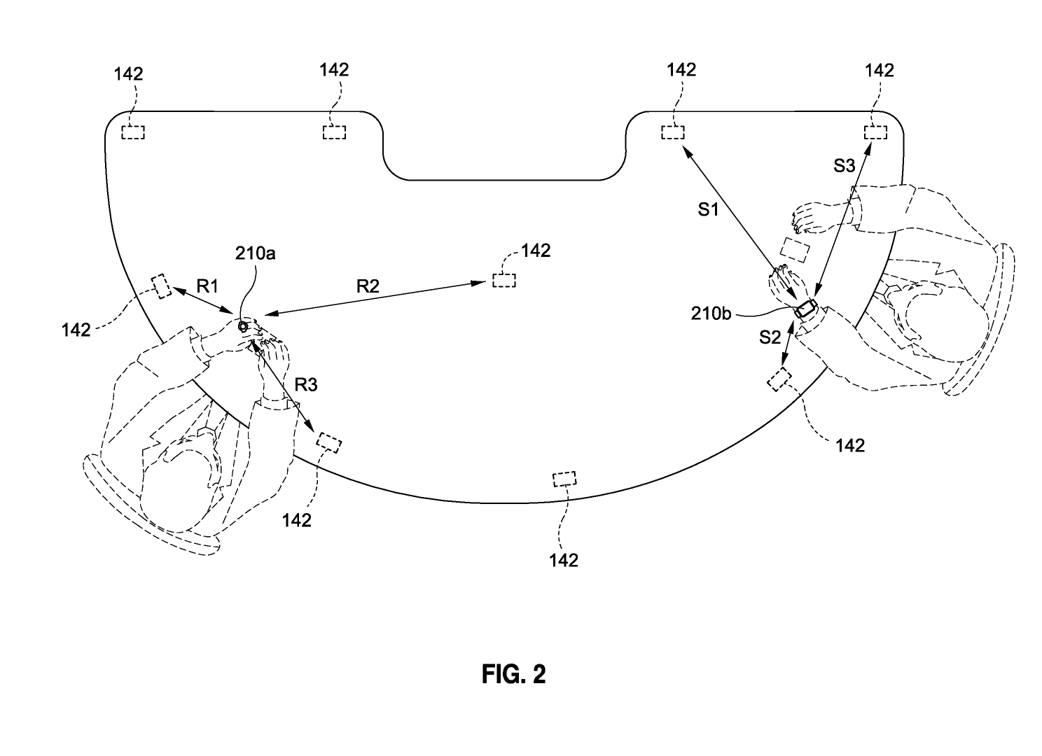

The WiFi readers detect the presence of one or more wireless devices 210, as shown in FIG. 2. The wireless devices 210 may be a WiFi enabled device having a wireless transmitter or transceiver and a power source, such as a battery. The wireless devices 210 may be implemented in a number of ways. Preferably, the wireless device 210a is associated with an element which is worn or held by a hand of a user so that, as described below, it can be used to determine the location of the user's hand. Thus, the device 210a might comprise or be associated with a wand or other element which is designed to be grasped or held by the hand of the user. In other configurations, the wireless device 210a may be configured as a part of a ring worn on the finger of a player. In another example, a wireless device may be a bracelet or a watch 210b.

The wireless devices 210 may be configured to have a unique identifier (such as a code, serial number, or the like) that is matched with a user of the device. In the context of a gaming environment, a casino or other gaming establishment may distribute and assign such wireless devices 210 in the form of bracelets or rings to players at the establishment. The wireless devices 210 may thus link to a player tracking system and a player's loyalty rewards account, a player's casino credit account, and the like, so that the device is matched or tied to a particular player. In other embodiments, the player may download an application that links a player's existing wireless device 210 to a gaming establishment network. In the manner, the player may use his or her own device as the wireless device 210. For example, the player may use his or her smartphone, smartwatch, or other device as the wireless device 210 via the downloaded application.

As a player plays a game at the gaming table 100, the position of the player's hand is tracked by way of the WiFi readers 142 and the wireless device 210. In one embodiment, an x-y plane may be defined by the playing surface 102, and the WiFi readers 142 are configured to locate the wireless device 210 within the x-y plane.

The wireless device 210 may be located within the x-y plane based on the readings received from the WiFi readers 142. For example, the wireless device 210 sends wireless signals via its wireless transceiver. The signals are received at the WiFi readers 142 of the gaming table 100. The WiFi readers 142 evaluate the strength of the signals received from the device 210 to determine a distance between the device 210 and the readers 142.

For example as shown in FIG. 2, a first device 210a is held by a first player over a table 100. In this example, the wireless device 210a is incorporated on a ring worn by the player. The player may be participating in a game on the table 100, and may be playing one or more cards or other gaming pieces, may be placing one or more wagers, or may be providing any other input or action relevant to the particular game being played. The wireless device 210a emits a wireless signal which is read by the WiFi readers 142.

The WiFi readers 142 evaluate the signal strength emitted from the wireless device 210a to determine a distance of the device 210a from the WiFi readers 142 or a relative distance in comparison with the other WiFi readers 142. In the configuration shown in FIG. 2, the wireless device 210a may be found to be a distance R1 from a first WiFi reader 142, a distance R2 from a second WiFi reader 142, and a distance R3 from a third WiFi reader. The WiFi readers 142 may send such information to a game table controller which triangulates the distances detected by the WiFi readers 142 to estimate the position of the device 210a relative to the playing surface 102 of the gaming table 100.

By estimating the position of the wireless device 210a relative to the table 100, a number of advantages to the table 100 may be obtained. For example, a controller of a table 100 may detect player actions simultaneously, even where the actions are not associated with a particular player's player station 114. In the example shown in FIG. 2, two players may simultaneously make wagers, play or draw from community cards, or perform other actions not associated with a particular player station 114. In fact, in the example shown in FIG. 2, the individual player stations 114 with corresponding inputs may be omitted completely. The device 210a is uniquely associated with the first player, and its location is estimated based on the distances R1, R2, and R3 derived from the signal strengths detected by the WiFi readers 142. Similarly, a device 210b (in this example, a watch or bracelet) is uniquely associated with the second player, and its location is estimated based on the distances S1, S2, and S3 derived from the signal strengths detected by the WiFi readers 142. Thus, any action associated with the position of the device 210a is attributable to the first player, while any action associated with the position of the device 210b is attributable to the second player.

In this way, the first player may play or draw a card to or from a community card area (or any other area), and simultaneously a second player may place a wager in a community area (or any other area). The table 100 may detect the cards or gaming pieces via known methods, such by RF tagging or image recognition, and then associate the position of those cards or gaming pieces with the position of the device 210a, and attribute the action to the first player. Similarly, the table may detect wagers via known methods, such as RF tagging a casino wagering chip or the like, and associate the position of the detected chip with the position of the device 210b, and attribute the action to the second player. By associating these actions with the identified player, a player tracking system or a casino account server may also be updated with information regarding player actions at the table 100.

As one example implementation, a casino might issue a first player ring to Player A. That first player ring may be coded with a unique identifier which is identifiable by the reader(s) 142. The casino may operate a player tracking system having an associated database which includes information about Player A, such as Player A's name, address, email, etc., and may include associated tracked game play data Likewise, the casino might issue a second player ring to Player B, which ring is coded with a second unique identifier.

In such a configuration, when Player A uses his or her ring at the gaming table 100, the readers 142 detect the location of the ring. A controller associated with the game table 100 may receive information regarding particular inputs or actions by Player A, as determined in part by the position of Player A's ring. Notably, the readers 142 may transmit location information as well as the unique identifier for Player A's ring to the controller. The controller may, in turn, communicate with the casino's player tracking system and utilize the identifier to determine the identity of Player A. Player A's identity might thus be provided to the Dealer. Further, game actions or activities by Player A may be associated with Player A, such as in the player tracking database. For example, Player A might reach out over the gaming table 100 to a “Place Bonus Bet” location. This action is detected and is determined to be a Player A action because of the tracked location of Player A's ring and the fact that Player A is known via his or her ring. The “Place Bonus Bet” action may thus be tracked at the player tracking database and that information might also be displayed or confirmed to the Dealer. For example, a Dealer display might display that “Player A has placed a bonus bet.”

As indicated above, actions by Player B may similarly be tracked and be distinguished from those actions of Player A, such as because of the use of a unique identifier with the rings.

It will be appreciated that the principles of the invention may be applied even when the identity of a player is not known—e.g. anonymous play. For example, at a gaming table player positions might be assigned as Position 1, Position 2, etc. A ring (or other wireless device) might be associated with each position. Thus, actions by a player at Position 1 are attributed to that player because they have been assigned and use the ring corresponding to that position, even though the actual identity of that player is not known.

Likewise, aspects of the invention may be implemented without a player tracking system and associated database, or may be implemented by or with other systems. For example, a system of the invention might include a simple controller and associated database via which game play or other information is associated with each wireless device (ring, etc.), without the identify of associated players being known.

Importantly, because the location of the device 210 uniquely associated with a player has a position that is tracked throughout the playing surface 102, all action corresponding to the position of the device 210 can be associated with the player. This enables the table 100 to receive input from multiple players simultaneously throughout the table 100 and associate the input with the correct player regardless of play order or whether the input was to a particular player station 114. This may allow a gaming establishment to provide for different types of games that allow fast, more exciting game play while tracking all game play via the table 100.

In one embodiment of the invention, the system and method may be used with a touch-screen type display. For example, a gaming table (or other gaming machine or device, as described below) might include a display having a touch-screen for receiving touch input. In accordance with the present invention, when a player touches a particular area of the display, that input may be detected and be matched to the player providing that input. In other words, by knowing the location of a player's hand, etc., input to the touch screen can be attributed to a particular player.

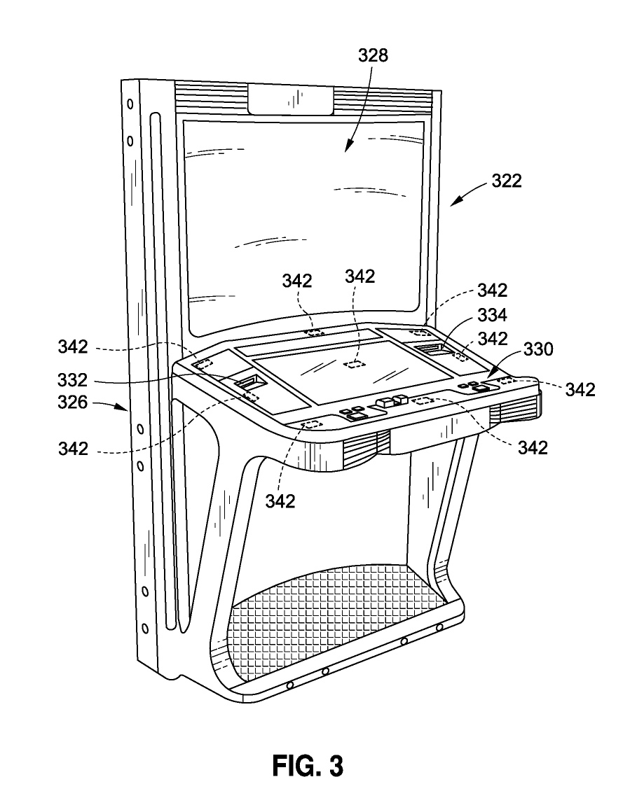

The above device tracking and multiple input system is not limited to a gaming table, as shown in FIGS. 1 and 2, but may be implemented on any device. The system, for example, may be implemented on a presentation screen and act as a wireless mouse as a presenter points to various locations on the presentation screen. The system may also be implemented on a person computing touchscreen, a kiosk, or an electronic gaming machine as shown in FIG. 3. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

One configuration of a gaming machine 322 is illustrated in FIG. 1. As illustrated, the gaming machine 322 generally comprises a housing or cabinet 326 for supporting and/or enclosing various components required for operation of the gaming machine. In the embodiment illustrated, the housing 326 includes a door located at a front thereof, the door capable of being moved between an open position which allows access to the interior, and a closed position in which access to the interior is generally prevented. The configuration of the gaming machine 322 may vary. In the embodiment illustrated, the gaming machine 322 has an “upright” configuration. However, the gaming machine 322 could have other configurations, shapes or dimensions (such as being of a “slant”-type, “bar-top” or other configuration as is well known to those of skill in the art).

The gaming machine 322 preferably includes at least one display device 328 configured to display game information. The display device 328 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 328 may be capable of projecting or displaying a wide variety of information, including images, symbols and other indicia or information associated with game play, game promotion or other events. The gaming machine 322 might include more than one display device 28, such as two or more displays 328 which are associated with the housing 326. The gaming machine 322 might also include a top box or other portion. Such a top box might include one or more display devices 28, such as in addition to one or more main displays which are associated with the housing 326. Also, the gaming machine 322 might include side displays (such as mounted to the exterior of the housing 26) and might include multiple displays of differing sizes.

The gaming machine 322 is preferably configured to present one or more games upon a player making a monetary payment or wager. In this regard, the gaming machine 322 includes a mechanism or means for accepting monetary value.

In one embodiment, prizes or awards may be provided for winning outcomes, such as monetary payments (or representations thereof, such as prize of credits), or promotional awards as detailed herein. The gaming machine 322 preferably includes a mechanism or means for returning unused monetary funds and/or dispensing winnings to a player.

The gaming machine 322 preferably includes one or more player input devices 330 (such as input buttons, plunger mechanisms, a touch-screen display, joystick, touch-pad or the like). These one or more devices 330 may be utilized by the player to facilitate game play, such as by providing input or instruction to the gaming machine 322. For example, such input devices 330 may be utilized by a player to place a wager, cause the gaming machine 322 to initiate a game, to indicate cards to be held or discarded, to “cash out” of the gaming machine, or to provide various other inputs.

In one preferred embodiment, the gaming machine 322 includes at least one microprocessor or controller for controlling the gaming machine, including receiving player input and sending output signals for controlling the various components or peripheral devices of the machine 322 (such as generating game information for display by the display 328). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 328, for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to loo-up tables, pay tables and other information, including tracked game play information). The gaming machine 322 may also include one or more random number generators for generating random numbers (such as implemented by a random number generator software module stored in the memory and executable by the processor or controller), such as for use in selecting slot symbols, cards or other game symbols and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the method of game play of the invention. In this regard, the gaming machine is specifically configured to present one or more games and implement the functionality of the invention via specific software and/or hardware which cases the gaming machine to operate in a unique manner. For example, the controller of the gaming machine 322 may be configured to detect a wager, such as a signal from a player's depressing of the “bet one” button. Upon such an event and/or the player otherwise signaling the gaming machine to present the game, the controller may be configured to cause game symbols or other game information to be displayed on the at least one display 328. The controller may accept input from a player of game inputs, such as a request to spin reels or the like, via the one or more player input devices of the gaming machine 322. As indicated above, the machine readable code may be configured in various manners, such as by having various “modules” of software which are designed to implement specific features of the game play or game presentation.

The gaming machine 322 may be configured to generate and present games in a stand-alone manner or it may be in communication with one or more external devices at one or more times. For example, the gaming machine 322 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 322 is configured to present one or more wagering games. The gaming machines 322 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 3, the gaming machine 322 might include a coin acceptor 332 for accepting coins. Of course, associated coin reading/verifying devices and coin storage devices may be associated with the gaming machine 322 if it is configured to accept coins. Likewise, the gaming machine 322 might include a media reader 334. Such a reader may be configured to accept and read/verify paper currency and/or other media such as tickets. Of course, in such event the gaming machine 322 may further be configured with one or more paper currency or ticket storage devices, such as cash boxes, and other paper currency or media handling devices (including transport devices).

The gaming machine 322 might also be configured to read FOBs, magnetic stripe cards or other media having data associated therewith and via which value or funds may be associated with the gaming machine 322. The mechanism for accepting monetary value might also comprise hardware and/or software which allows a player to transfer (such as electronically) funds form an account, such as a casino wagering account, or a bank or other financial institution account. Such a mechanism might include a communication interface which permits the gaming machine to communicate with a mobile phone, a PDA, a tablet or other electronic device of the player (such as via a physical interface or wired or wireless communication links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 322 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 322 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 322 may also include a player tracking device, such as a via media reader 334 and an associated keypad. Such player tracking devices are well known and may permit the game operator to track play of players of the gaming machine. The tracked play may be utilized to offer player bonuses or awards.

A casino may have numerous such gaming machines 322, such as located on a casino floor or in other locations. Of course, such gaming machines 322 might be used in other environments, such as an airport, a bar or tavern or other locations. The gaming machine may be part of a system which includes other devices. For example, the gamin machine may communicate with one or more casinos systems, such as a player tracking server or system, an accounting system or server, a ticketing system, a bonusing system, a tournament system, or other gaming machines and external devices.

The gaming machine 322 may comprise a number of WiFi readers 342 embedded within the gaming machine 322. For example, the WiFi readers 342 may be embedded along a surface of the gaming machine corresponding to the plurality of input devices 330. As shown in FIG. 3, there may be eight WiFi readers 342 along a periphery of the controls 330 and a WiFi reader 342 in the center of the controls 330. The WiFi readers 342 may be communicatively linked to the gaming controller.

Similar to the WiFi readers 142, the WiFi readers 342 may detect the presence of a WiFi enabled wireless device. Thus, as explained above, the gaming machine 322 may be configured to track the position of the wireless device, and associate an action taken by a player on the controls 330 with the position of the wireless device. In this manner, the gaming machine 322 may be configured to allow input from more than one player utilizing the same control inputs 330 by detecting the location of the different devices and associating inputs with the location of the devices.

It will be appreciated that the gaming machine illustrated in FIG. 3 is only exemplary of one embodiment of a gaming machine. For example, it is possible to for the gaming machine to have various other configurations, including different shapes and styles and having different components than as just described.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming device comprising:
a controller;
at least one player input device configured to receive input from multiple players relative to at least one game presented at the gaming device, each player having a wireless identifier; and
at least three wireless signal detectors, the wireless signal detectors being configured to detect a strength of a wireless signal received by the detectors from each wireless identifier and the controller triangulating a position of the source of the received wireless signal, the detectors configured to provide an output to said controller, whereby said controller associates action by a player as identified by said wireless identifier with an input to said at least one input device.

2. The gaming device according to claim 1, wherein the gaming device is a casino gaming machine, and the at least three wireless signal detectors are embedded within a surface comprising one or more input devices of the gaming device.

3. The gaming device according to claim 1, wherein the gaming device is a gaming table, and the at least three wireless signal detectors are embedded within a playing surface of the gaming table.

4. A method for receiving input from multiple players relative to at least one game presented at a gaming device, the method comprising:
receiving at the gaming device an input via one or more input devices from a first player and a second player, the first player and the second player each having a wireless identifier;
detecting via at least three wireless signal detectors on the gaming device a signal strength of a wireless signal from each wireless identifier;
triangulating via a controller of the gaming device a position of a source of the wireless signal based on the detected signal strength and associating the source with the wireless identifier; and
associating, via the controller, the input from the first player based on the position of the wireless identifier of the first player and the input from the second player based on the position of the wireless identifier of the second player.
